(19) United States
(12) Patent Application Publication
(10) Pub. No.: US 2012/0079594 A1
(43) Pub. Date: Mar. 29, 2012

(54) MALWARE AUTO-ANALYSIS SYSTEM AND METHOD USING KERNEL CALLBACK MECHANISM

(76) Inventors: HYUN CHEOL JEONG, Seoul (KR); Chae Tae Im, Seoul (KR); Joo Hyung Oh, Seoul (KR)

(21) Appl. No.: 12/942,700

(22) Filed: Nov. 9, 2010

(30) Foreign Application Priority Data
Sep. 27, 2010 (KR) 10-2010-0093308

(51) Int. Cl. G06F 11/00

(52) U.S. Cl. 726/23

(57) ABSTRACT

In a malware auto-analysis method using a kernel callback mechanism, a function, present in a kernel driver within a PsSetCreateProcessNotifyRoutine function, is registered by a process monitor driver as a callback function when a computer boot. A function present in a registry monitor driver is registered by the registry monitor driver as a callback function in a CmRegisterCallback function when the driver is loaded. A kernel driver is registered by a file monitor driver as a mini-filter driver in a Filter Manager present in a Windows system. At least one of a process event, a registry event, or an Input/Output (I/O) event is received by a behavior event collector from the process monitor driver, the registry monitor driver, or the file monitor driver, respectively.

### BACKGROUND OF THE INVENTION

1. Field of the Invention

The present invention relates, in general, to a malware auto-analysis system and a method using a kernel callback mechanism, and, more particularly, to a technology for providing behavior analysis at a kernel level without causing efficiency problems because behavior monitoring is possible using callback functions registered in kernel managers without a need to inject a separate hooking code.

2. Description of the Related Art

As shown in FIG. 1, because new/mutant malicious code (i.e., malware) has rapidly increased, damage attributable to cyber attacks using malware such as 7.7 DDoS attacks has continuously increased, and the seriousness of cyber attacks has gradually increased because of an amount of monetary damage involved.

Further, since 80% or more of collected malware uses, for example, kernel rootkits, run-time packers, and Dynamic Link Library (DLL) binary code injection to interrupt and delay analysis, it is difficult to promptly cope with such malware.

In order to cope with rapidly increasing amount of malware, most anti-virus vendors primarily and rapidly select fatal threatening malware by utilizing an automation system for analyzing malware behavior. An analysis technology using a Windows system hooking technique has been generally used for automatically analyzing malware.

Malware auto-analysis technology using an application-level Application Programming Interface (API) hooking is advantageous in that construction of a system can be promptly implemented without requiring in-depth knowledge of Windows kernels. However, it has some disadvantages in that it is difficult to analyze malware running at the kernel level.

Meanwhile, the technology for analyzing the malware behavior at the kernel level is advantageous in that the behavior of malware running at the kernel level can be analyzed because a hooking code for behavior monitoring is injected into Windows kernel objects such as a System Service Descriptor Table (SSDT) or an Interrupt Descriptor Table (IDT). However, it is difficult to analyze the behavior of malware that uses the same hooking technology. Also, efficiency may be lowered due to system hooking.

A conventional malware behavior analysis technology places a greater focus on monitoring the API that is called by malware, analyzing an API call pattern, and detecting the behavior of the malware. However, it is difficult to analyze malware having kernel rootkit functions in the conventional method, and an efficiency problem may occur when a large amount of malware needs to be analyzed.

As shown in FIG. 2, Sunbelt's CWSandbox runs malware for a virtual environment-based analysis, and injects a monitoring module, that is, a ‘CWMonitor.dll’ file, into the thread of a malicious process. Windows API call information, created while malware is running after the injection of the monitoring module, is hooked using an API hooking technique, and then file, registry, and process creation events are analyzed. However, since CWSandbox uses Win32 API calls, it is difficult to analyze malware running at the kernel level, such as occurs in I/O Request Packet (IRP) message creation or native API calls performed in the Windows kernel area.

Meanwhile, Ikarus software's TTAnalyze as shown in FIG. 3, and ZeroWine, which is an open project, monitor instructions of malware processed by a processor emulator (QEMU), and extract API call information. The QEMU translates the instructions of the malware one by one, and virtually executes the instructions as if they were actually executed on a Central Processing Unit (CPU). Therefore, the delay of analysis time occurs due to a sequential execution of the instructions.

Further, Ether proposed by Artem Dinaburge, et al., as shown in FIG. 4, is a tool developed to incapacitate malware's function of detecting a virtual environment. Currently, Ether enables only the monitoring of the malware behavior. Since such Ether runs malware in a hardware-based virtualization system using both a CPU and Xen 3.0 to which Intel-Virtualization Technology (VT) is applied, it provides a function of incapacitating malware from detecting various types of virtual environments. However, since all instructions that are created to run malware are analyzed and filtered, monitoring a specific behavior such as file writing is complicated to perform.

### SUMMARY OF THE INVENTION

Accordingly, the present invention has been made keeping in mind the above problems occurring in the prior art, and an object of the present invention is to provide a malware auto-analysis system using a kernel callback mechanism, which can monitor malware, to which an intelligent analysis interference technique is applied, at the kernel level, and can prevent system efficiency from being deteriorated due to behavior monitoring.

Another object of the present invention is to perform behavior monitoring using callback messages created by registering callback functions in kernel managers such as an I/O filter, a process and registry which are present in a Windows kernel, and to provide behavior monitoring at the kernel level without deteriorating system efficiency while preventing analysis errors attributable to the injection of hooking code from occurring.

In order to accomplish the above objects, the present invention provides a malware auto-analysis system using a kernel callback mechanism, comprising a process monitor driver configured to register a first function present in a kernel driver as a first callback function by using a PsSetCreateProcessNotifyRoutine function to receive a process event attributable to creation and/or termination of a process; a registry monitor driver configured to register a second function present therein as a second callback function by using a CmRegisterCallback function when the registry monitor driver is loaded to receive a registry event; a file monitor driver configured to register the kernel driver as a minifilter driver in a Filter Manager present in a Windows system to receive a file-related Input/Output (I/O) event; and a behavior event collector configured to select and store data corresponding to a preset monitoring target process in a preset shared memory region based on at least one of the process event, the registry event or the I/O event received via a shared memory that can be simultaneously accessed by the kernel driver and an application program.

Further, the present invention provides a malware auto-analysis method using a kernel callback mechanism based on the above system, comprising registering, by a process monitor driver, a function, present in a kernel driver within a PsSetCreateProcessNotifyRoutine function, as a callback function when a computer boots; registering, by a registry monitor driver, a function present therein as a callback function in a CmRegisterCallback function when the driver is loaded; registering, by a file monitor driver, a kernel driver as a mini-filter driver in a Filter Manager present in a Windows system; and receiving, by a behavior event collector, at least one of, a process event, a registry event, or an Input/Output (I/O) event from the process monitor driver, the registry monitor driver, or the file monitor driver, respectively.

### BRIEF DESCRIPTION OF THE DRAWINGS

FIG. 1 is a diagram showing statistical results of collected malware;

FIG. 2 is a diagram showing a configuration of a conventional CWSandbox system;

FIG. 3 is a diagram showing a configuration of a conventional TTAnalyze system;

FIG. 4 is a diagram showing a configuration of a conventional Ether system;

FIG. 5 is a diagram showing a configuration of a malware auto-analysis system using a kernel callback mechanism according to the present invention;

FIG. 6 is a diagram showing a configuration of a callback mechanism module of the malware auto-analysis system using the kernel callback mechanism according to the present invention;

FIG. 7 is a diagram showing monitoring efficiency of the malware auto-analysis system using the kernel callback mechanism according to the present invention;

FIG. 8 is a flowchart showing a malware auto-analysis method using the kernel callback mechanism according to the present invention; and

FIG. 9 is a flowchart showing a procedure following step S40 in the malware auto-analysis method using the kernel callback mechanism according to the present invention.

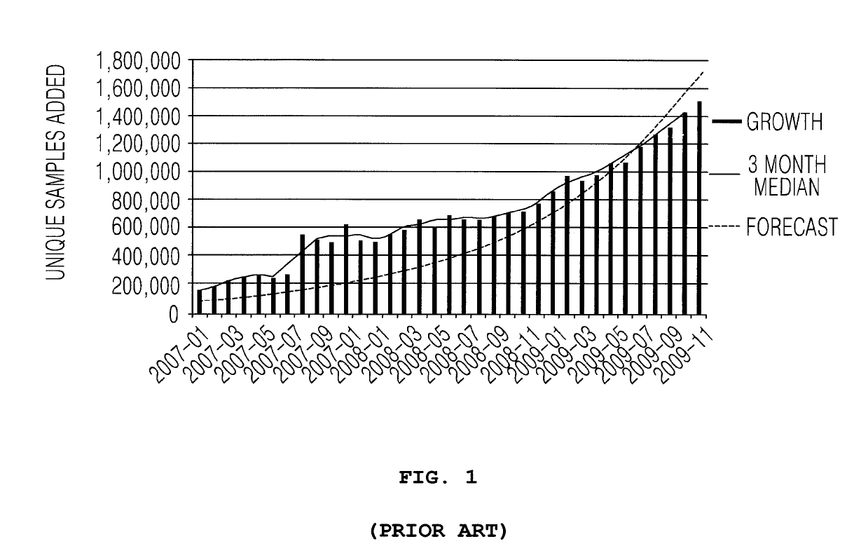

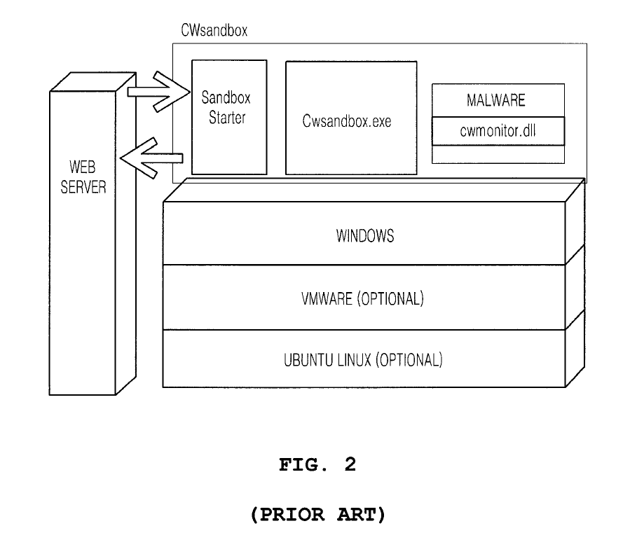

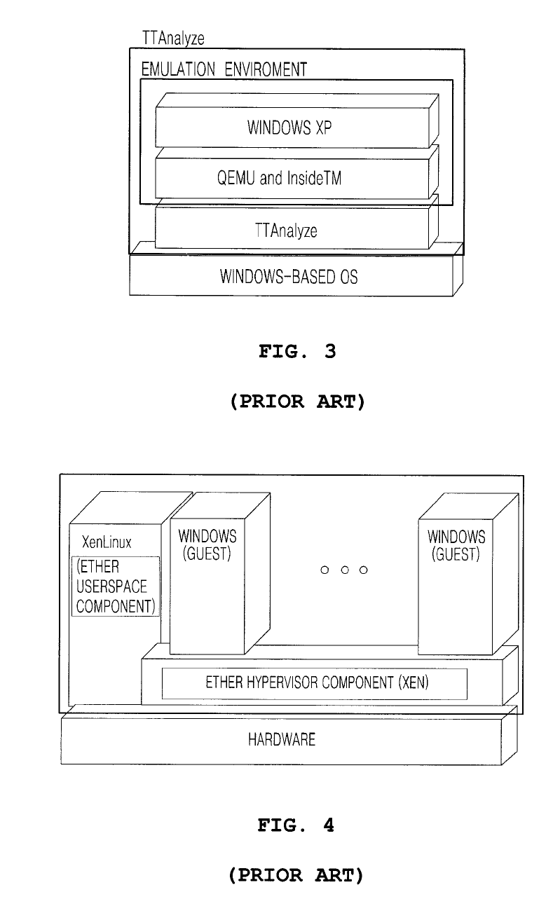

### DESCRIPTION OF THE PREFERRED EMBODIMENTS

The above and other objects, features and advantages of the present invention will be more clearly understood from the following detailed description taken in conjunction with the accompanying drawings. Prior to giving the description, the terms and words used in the present specification and claims should be interpreted to have the meaning and concept relevant to the technical spirit of the present invention on the basis of the principle by which the inventor can suitably define the implications of terms in the way which best describes the invention. Further, in the description of the present invention, if detailed descriptions of related well-known constructions or functions are determined to make the gist of the present invention unclear, the detailed descriptions may be omitted.

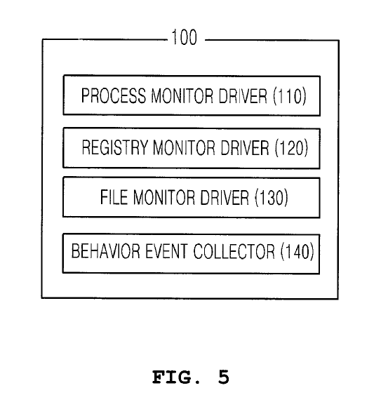

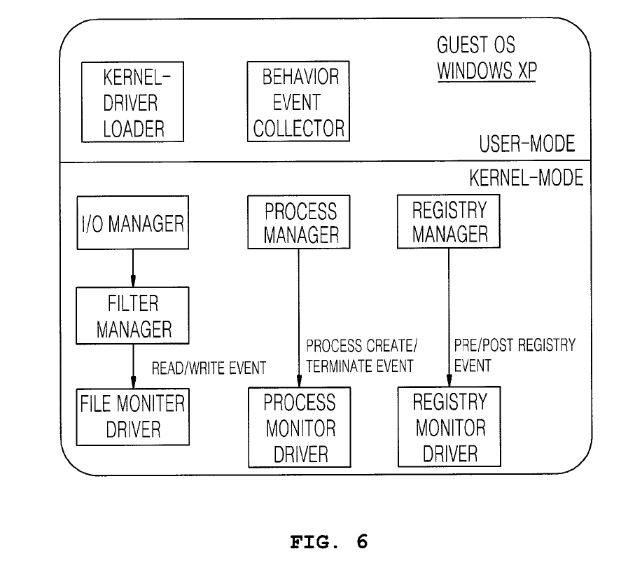

As shown in FIGS. 5 and 6, a malware auto-analysis system 100 using a kernel callback mechanism according to the present invention includes a process monitor driver 110, a registry monitor driver 120, a file monitor driver 130, and a behavior event collector 140.

In detail, the process monitor driver 110 registers a function, present in a kernel driver within a PsSetCreateProcessNotifyRoutine function, as a callback function at the time at which a computer boots, and then receives process creation and termination events.

The registry monitor driver 120 registers a function present therein as a callback function in a CmRegisterCallback function at the time at which the driver is loaded, and then receives registry events.

The file monitor driver 130 registers a kernel driver itself as a minifilter driver in a Filter Manager present in the Windows system, and then receives file-related Input/Output (I/O) events.

The behavior event collector 140 receives the process events, the registry events and the I/O events (hereinafter referred to as ‘monitoring data’) via a shared memory that can be simultaneously accessed by the kernel drivers and application programs. In this case, the behavior event collector 140 selects only data corresponding to a preset monitoring target process from among monitoring data, and stores the selected data in a predefined shared memory region.

Further, the behavior event collector 140 periodically accesses the shared memory region at regular periods, and examines whether newly stored data is present in the shared memory region. In this case, if the newly stored data is present in the shared memory region, the behavior event collector 140 reads the monitoring data from each of the process monitor driver 110, the registry monitor driver 120, and the file monitor driver 130.

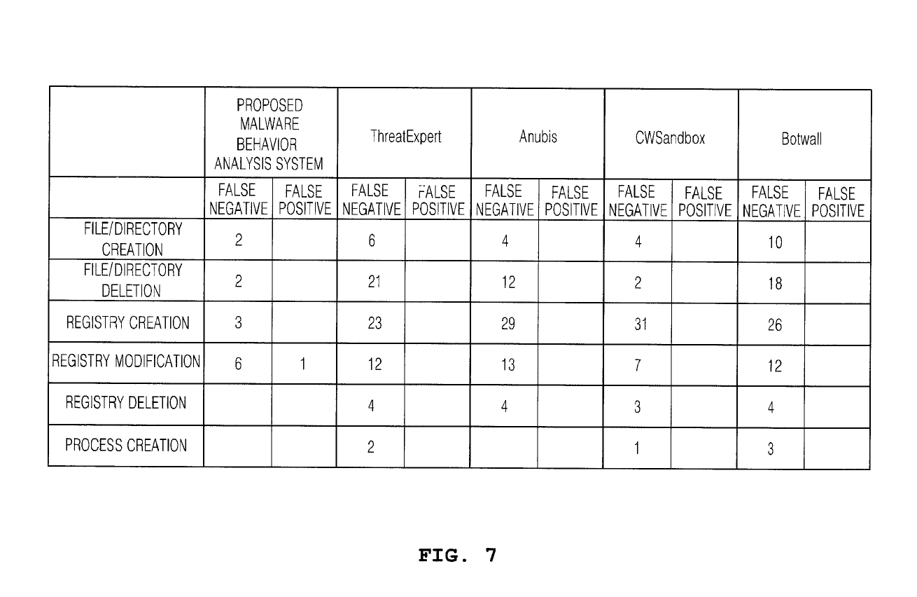

Hereinafter, the monitoring efficiency of the malware auto-analysis system using the kernel callback mechanism according to the present invention will be described with reference to FIG. 7.

An efficiency test according to the present invention is conducted to compare efficiency of false negative analysis and false positive analysis of behavior of the system of the present invention and commercial/open analysis systems, which analyze the latest 108 kinds of malware collected by a malware sharing community or the like.

Ikarus software's TTAnalyze is replaced by Anubis which is an upgrade version, and Ether does not provide an analysis function and is then replaced by ThreatExpert and Botwall. Further, the number of false negatives and the number of false positives are measured on the basis of behaviors that are equally detected by three or more kinds of analysis systems using results of analysis performed by five kinds of malware analysis systems.

For example, in case of a file event “C:\malware.exe creation” of malware A detected by three or more kinds of analysis systems, the number of false negatives of the two remaining analysis systems which do not detect the file event is increased by ‘1’. Further, when the file event of the same malware A is analyzed as “C:\tests.exe creation”, the number of false positives is increased by ‘1’.

That is, as shown in the results of the efficiency evaluation of FIG. 7, the malware behavior analysis technology using the kernel mechanism proposed in the present invention exhibits a lower false negative rate and a lower false positive rate than other analysis systems.

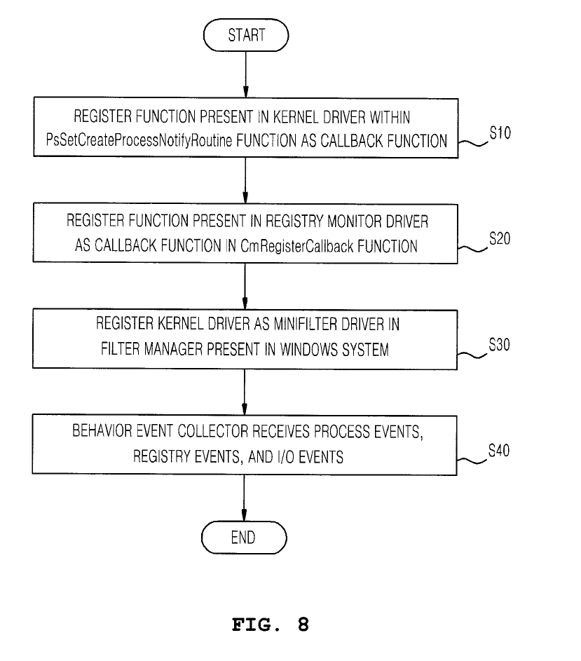

Hereinafter, a malware auto-analysis method using the kernel callback mechanism according to the present invention will be described with reference to FIG. 8.

As shown in FIG. 8, the process monitor driver 110 registers a function, present in a kernel driver within a PsSetCreateProcessNotifyRoutine function, as a callback function at the time at which a computer boots at step S10.

Then, the registry monitor driver 120 registers a function present therein as a callback function in a CmRegisterCallback function at the time at which the driver is loaded at step S20.

Thereafter, the file monitor driver 130 registers a kernel driver as a minifilter driver in a Filter Manager present in the Windows system at step S30.

Further, the behavior event collector 140 receives process events, registry events, and I/O events from the process monitor driver 110, the registry monitor driver 120, and the file monitor driver 130, respectively, at step S40.

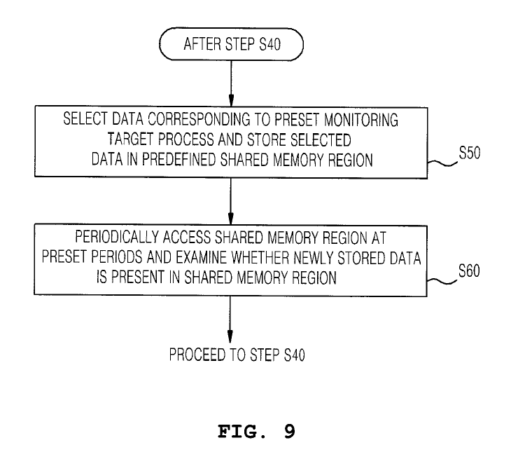

A procedure after step S40 of the malware auto-analysis method using the kernel callback mechanism according to the present invention will be described with reference to FIG. 9.

The behavior event collector 140 selects only data corresponding to a preset monitoring target process from among the process events, the registry events, and the I/O events (monitoring data), and stores the selected data in a predefined shared memory region at step S50.

Further, the behavior event collector 140 periodically accesses the shared memory region at preset periods, and examines whether newly stored data is present in the shared memory region at step S60. If the newly stored data is present as a result of the examination at step S60, the process proceeds to step S40 where monitoring data is read from each of the process monitor driver 110, the registry monitor driver 120 and the file monitor driver 130.

Accordingly, the present invention is advantageous in that it automatically analyzes malware using the kernel callback mechanism such that system efficiency can be prevented from being deteriorated due to behavior monitoring while malware to which an intelligent analysis interference technique is applied can be monitored at the kernel level.

Further, the present invention is advantageous in that it performs behavior monitoring using callback messages created by registering callback functions in kernel managers such as an I/O filter, a process and registry which are present in Windows kernels, thus avoiding analysis errors attributable to injection of the hooking code and providing behavior monitoring at the kernel level without deteriorating system efficiency.

Although the preferred embodiments of the present invention have been disclosed for illustrative purposes, those skilled in the art will appreciate that various modifications and changes are possible, without departing from the scope and spirit of the invention as disclosed in the accompanying claims. Therefore, all suitable modifications and changes and equivalents thereof should be interpreted as being included in the scope of the present invention.

1. A malware auto-analysis system using a kernel callback mechanism, comprising:
a process monitor driver configured to register a first function present in a kernel driver as a first callback function by using a PsSetCreateProcessNotifyRoutine function to receive a process event attributable to creation and/or termination of a process;
a registry monitor driver configured to register a second function present therein as a second callback function by using a CmRegisterCallback function when the registry monitor driver is loaded to receive a registry event;
a file monitor driver configured to register the kernel driver as a minifilter driver in a Filter Manager present in a Windows system to receive a file-related Input/Output (I/O) event; and
a behavior event collector configured to select and store data corresponding to a preset monitoring target process in a preset shared memory region based on at least one of, the process event, the registry event or the I/O event received via a shared memory that can be simultaneously accessed by the kernel driver and an application program.

2. The malware auto-analysis system according to claim 1, wherein
the behavior event collector periodically accesses the shared memory region at preset periods and determines whether newly stored data is present in the shared memory region, and
if it is determined that the newly stored data is present in the shared memory region, the behavior event collector reads monitoring data, which includes at least one of, the process event, the registry event, or the I/O event, from the process monitor driver, the registry monitor driver, or the file monitor driver, respectively.

3. A malware auto-analysis method using a kernel callback mechanism, comprising:
registering, by a process monitor driver, a function, present in a kernel driver within a PsSetCreateProcessNotifyRoutine function, as a callback function when a computer boots;
registering, by a registry monitor driver, a function present therein as a callback function in a CmRegisterCallback function when the driver is loaded;
registering, by a file monitor driver, a kernel driver as a mini-filter driver in a Filter Manager present in a Windows system; and
receiving, by a behavior event collector, at least one of, a process event, a registry event, or an Input/Output (I/O) event from the process monitor driver, the registry monitor driver, or the file monitor driver, respectively.

4. The malware auto-analysis method according to claim 3, further comprising,
selecting, by the behavior event collector, data corresponding to a preset monitoring target process from the at least one of, the process event, the registry event, or the I/O event which forms monitoring data, and storing the selected data in a preset shared memory region.

5. The malware auto-analysis method according to claim 4, further comprising:
collector periodically accessing, by the behavior event collector, the shared memory region at preset periods to determine whether newly stored data is present in the shared memory region, and proceeding to the receiving step in which the monitoring data is read from each of the process monitor driver, the registry monitor driver, or the file monitor driver if the newly stored data is determined to be present in the shared memory region.

6. A computer-assisted method of automatically detecting malware, the method comprising:
registering a first callback function in a process kernel manager to receive a process event attributable to creation and/or termination of a process;
registering a second callback function in a registry kernel manager to receive a registry event;
registering a third callback function in an Input/Output (I/O) kernel manger to receive a file read/write event; and
analyzing a newly stored data in a shared memory between a kernel driver and an application program, wherein the newly stored data is collected based on monitoring data that includes at least one of, the process event, the registry event or the file read/write event.

7. The method according to claim 6, wherein the newly stored data corresponds to a preset monitoring target process.

8. The method according to claim 6, wherein the process kernel manager uses a PsSetCreateProcessNotifyRoutine function.

9. The method according to claim 6, wherein the registry kernel manager uses a CmRegisterCallback function.

10. The method according to claim 6, wherein the I/O kernel manager uses the kernel driver by registering the kernel driver as a mini-filter driver in a Filter Manager present in a Windows system.
